(19) United States
(12) Patent Application Publication
(10) Pub. No.: US 2014/0380280 A1
(43) Pub. Date: Dec. 25, 2014

(54) DEBUGGING TOOL WITH PREDICTIVE FAULT LOCATION

(71) Applicant: INTERNATIONAL BUSINESS MACHINES CORPORATION, ARMONK, NY (US)

(72) Inventor: Daniel N. Millwood, Southampton (GB)

(21) Appl. No.: 13/926,816

(22) Filed: Jun. 25, 2013

(51) Int. Cl. G06F 11/36

(52) U.S. Cl. CPC G06F 11/362
USPC 717/127

(57) ABSTRACT

Identifying a code segment that has a likelihood of causing a program failure. Program code is executed to a failure point. A plurality of code segments executed in the program code prior to the failure point are identified. Changesets that contain at least one of the identified code segments are identified. The identified code segments are then ranked as a function of likelihood that each respectively ranked identified code segment caused the failure point, based, at least in part, on the identified changesets. In another aspect of the invention, at least some of the ranked code segments along with an indication of the ranking are reported.

### FIELD OF THE INVENTION

The present invention relates generally to the field of software development testing and debugging, and more particularly to providing predictive information on portions of tested code more likely to have caused a fault, based on change history of the tested code.

### BACKGROUND OF THE INVENTION

Debugging program code can be a complicated and time-consuming process. The problem can be compounded if the developer who is debugging the program code did not write the code and is not familiar with the code. While it may be relatively easy to recreate an execution failure, it may prove difficult to locate the cause of the failure.

### SUMMARY

Embodiments of the present invention disclose a method, computer program product, and system for identifying a code segment that has a likelihood of causing a program failure. Program code is executed to a failure point. A plurality of code segments executed in the program code prior to the failure point are identified. Changesets that contain at least one of the identified code segments are identified. The identified code segments are then ranked as a function of likelihood that each respectively ranked identified code segment caused the failure point, based, at least in part, on the identified changesets. In another aspect of the invention, at least some of the ranked code segments along with an indication of the ranking are reported.

### BRIEF DESCRIPTION OF THE SEVERAL VIEWS OF THE DRAWINGS

FIG. 1 is a functional block diagram showing a predictive fault location system, in accordance with an embodiment of the present invention.

FIG. 2 is a functional block diagram showing a debugger module within the predictive fault location system of FIG. 1, in accordance with an embodiment of the present invention.

FIG. 3 is a flowchart showing operational steps of a predictive fault location system of FIG. 1, in accordance with an embodiment of the present invention.

FIG. 4 is a block diagram of components of the computing device executing the predictive fault location system, in accordance with an embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF (radio frequency signals), etc., or any suitable combination of the foregoing.

Computer program code for carrying out operations for aspects of the present invention may be written in any combination of one or more programming languages, including an object oriented programming language such as Java®, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/actions specified in the flowchart and/or block diagram block or blocks.

Embodiments of the present invention generally describe a program code debugger embodying a predictive fault location system that will assist a developer in identifying locations in program code that are more likely than other locations to be the cause of a program failure. The debugger executes a portion of program code to failure, and records, for example, the classes and methods that are accessed. The developer provides keywords, such as individual words, phrases, or a natural language description of the failure, which is then used, for example, to identify defect entries in a version control database. Associated changesets are identified. Classes and methods in the associated changesets are ranked, for example, by the number of changesets that contain the classes and methods, and some number of higher ranked changesets are then presented to the developer as more likely to be the cause of the program code failure.

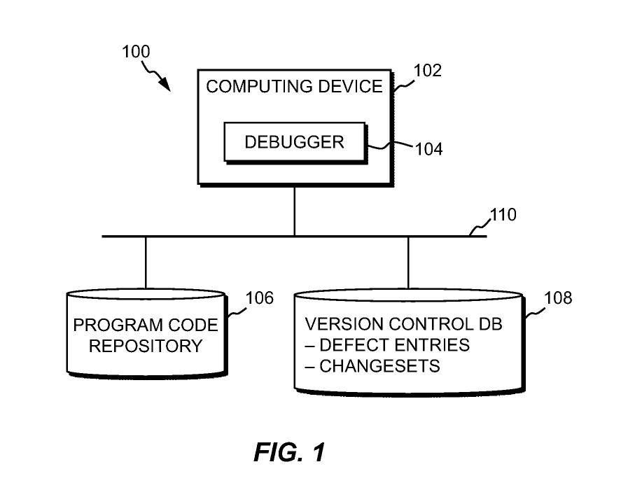

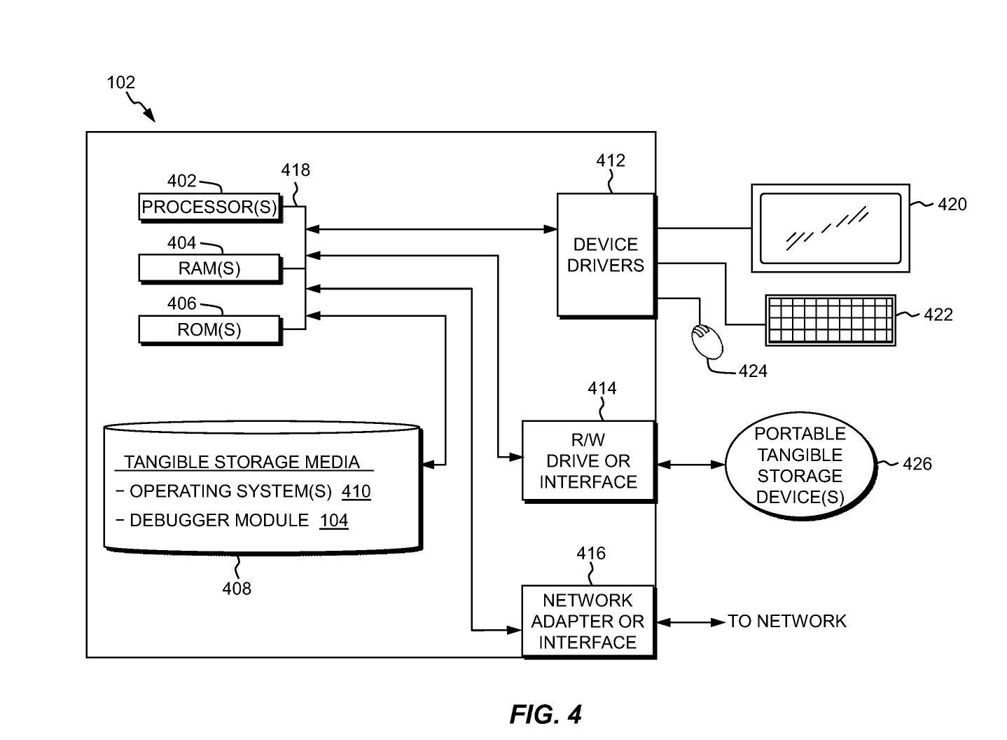

The present invention will now be described in detail with reference to the figures. FIG. 1 is a functional block diagram illustrating a predictive fault location system, generally designated 100, in accordance with one embodiment of the present invention. Predictive fault location system 100 includes computing device 102, program code repository 106, and version control database 108, all interconnected over network 110. Network 110 can be, for example, a local area network (LAN), a wide area network (WAN) such as the Internet, or a combination of the two, and can include wired, wireless, or fiber optic connections. In certain embodiments, network 110 can also be the communications fabric within computing device 110, for example, communications fabric 418 (see FIG. 4). In general, network 110 can be any combination of connections and protocols that will support communications between computing device 102, program code repository 106, and version control database 108.

In an exemplary embodiment, program code repository 106 is a database, or other data store, that contains, for example, current program code for programs, program modules, classes, methods, objects, subroutines, functions, procedures, divisions, or other code segments that may be related to one or more projects under development or maintenance. Program code repository 106 resides on a computer-readable storage medium, such as tangible storage media 408 (see FIG. 4).

In an exemplary embodiment, version control database 108 is associated with a version control system (not shown) for managing changes to the program code in program code repository 106. Among other information in version control database 108, the database includes defect entries that include, for example, descriptions, symptoms, locations, causes, fixes, and other information associated with program bugs discovered during testing and execution of program code in program code repository 106. Version control database 108 also contains changesets that record revisions made to program code in program code repository 106 to fix discovered program bugs. Each changeset may be associated with one or more defect entries, and each defect entry is associated with one or more changesets. Information included in a changeset may include, for example, the name of code segments that are changed, the defect(s) to which the changeset is related, the time of each revision, and the size of each revision, for example, the number of lines of program code that were changed. How “central” a piece of program code is may be determined based on the number of different or unrelated defect entries to which the piece of program code is related.

While in FIG. 1, program code repository 106 and version control database 108 are shown as separate databases, one of skill in the art will appreciate that, in other embodiments, other configurations may be used. For example, the databases may be integrated into a single database, and may, for example, only be accessible to computing device 102 via other computing systems, such as network servers coupled to network 110.

Computing device 102 includes debugger module 104. In various embodiments of the present invention, computing device 102 can be a laptop computer, a notebook computer, a personal computer, a desktop computer, a tablet computer, a handheld computing device, a thin client, a mainframe computer, a networked server computer, or any programmable electronic device capable of supporting the functionality of debugger module 104, and communicating with program code repository 106 and version control database 108 within predictive fault location system 100. Computing device 102 may include internal and external components, as depicted and described with respect to FIG. 4.

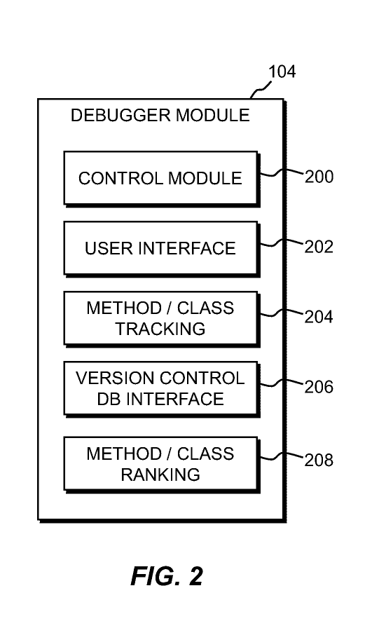

FIG. 2 is a functional block diagram showing debugger module 104 of computing device 102 within predictive fault location system of FIG. 1, in accordance with an embodiment of the present invention. Debugger module 104 is a computer program that executes on computing device 102, and may be used by a developer to assist in locating the cause of a failure in a program under test. Debugger module 104 includes control module 200, user interface 202, method and class tracking module 204, version control database interface 206, and method and class ranking module 208.

Control module 200 controls the operation of debugger module 104, such as the operation of user interface 202, method and class tracking module 204, version control database interface 206, and method and class ranking module 208, in accordance with embodiments of the invention.

User interface 202 allows a developer to interact with debugger module 104, for example, by setting breakpoints, stepping through executable program statements, and other common debugging tasks. In certain embodiments, user interface 202 also allows a developer to enter keywords or a natural language description of a failure, such as symptom of the failure, in a program under test for which the developer is using the debugger to determine a cause of the failure, and provides information to the developer to assist in locating code in the program under test that may be the cause of the failure, in accordance with embodiments of the invention, as described in more detail below. In certain embodiments, a language parser may be used to identify significant words and phrases contained in a natural language description of the failure entered by the developer.

Method and class tracking module 204 operates to maintain a list of, for example, methods and classes that are invoked during the execution of a portion of code under test. For example, a developer may be trying to determine the cause of the failure of a program module by recreating the failure. The program module is loaded to debugger module 104, and executed to failure. Method and class tracking module 204 determines and records each method and class that is invoked by the program module to the point of failure. For example, method and class tracking module 204 may record the method and class name, how many times the method was invoked, the timestamps of when the method was entered and exited, and the identity of the thread executing the method. Although the exemplary embodiment describes operation in the context of debugging object oriented code, one of skill in the art will appreciate that, in other embodiments, other code segments may be tracked, based on the language and the environment in which the program code undergoing debugging was developed. For example, besides tracking methods and classes invoked by a program under test, method and class tracking module 204 may also track program modules, objects, subroutines, functions, procedures, divisions, or other code segments invoked.

Version control database interface 206 operates to identify defect entries in version control database 108 that contain keywords and phrases entered by the developer via user interface 202 that describe the failure, and to identify changesets associated with the identified defect entries. Version control database interface 206 also operates to receive from method and class tracking module 204 the list of methods and classes that are invoked during the execution of a portion of code under test. A changesets is determined to be an “identified changeset” if it meets both of the following conditions: (i) it is associated with one or more identified defect entries; and (ii) contains one or more of the methods and classes that were invoked during the execution of a portion of code under test. The identity of the identified changesets (in this embodiment keying off of method or class) is passed to method and class ranking module 208 for analysis.

In an alternative embodiment, keywords or a natural language description that describe the failure are not entered, or are optionally entered, by the developer. In these embodiments, for example, version control database interface 206 receives from method and class tracking module 204 the list of methods and classes that were invoked during the execution of the portion of code under test, and identifies changesets in version control database 108 that contain the methods and classes. In this alternative embodiment, there is no requirement that an identified changeset must be associated with any keywords or phrases. This information, at least keying off of method or class, is passed to method and class ranking module 208 for analysis.

Method and class ranking module 208 operates to rank the list of methods and classes received from version control database interface 206 as a function of likelihood of cause of failure. For example, the list of methods and classes may be ranked by the number of changesets that contain the classes and methods, the number of revisions made to method or class, the time of each revision, the size of a revision, for example, the number of lines of program code that were modified, and how often a class or method is referenced in changesets of different or unrelated defect entries. The higher ranked changesets may then be presented to the developer, via user interface 202, as more likely to be the cause of the program code failure.

The functionalities represented by control module 200, user interface 202, method and class tracking module 204, version control database interface 206, and method and class ranking module 208 may be, for example, subdivided along different functional boundaries, or distributed across more computing systems than are depicted. Method and class tracking module 204, version control database interface 206, and method and class ranking module 208 may be, for example, implemented as features of debugger module 104, or implemented as extensions, add-ons, or plugins to debugger module 104. In a preferred embodiment, debugger module 104 is a commercially available, open source, or proprietary debugger program that implements the functionality of control module 200, user interface 202, method and class tracking module 204, version control database interface 206, and method and class ranking module 208, in accordance with embodiments of the invention, or allows for modifications in the form of extensions, add-ons, or plugins to support such functionality.

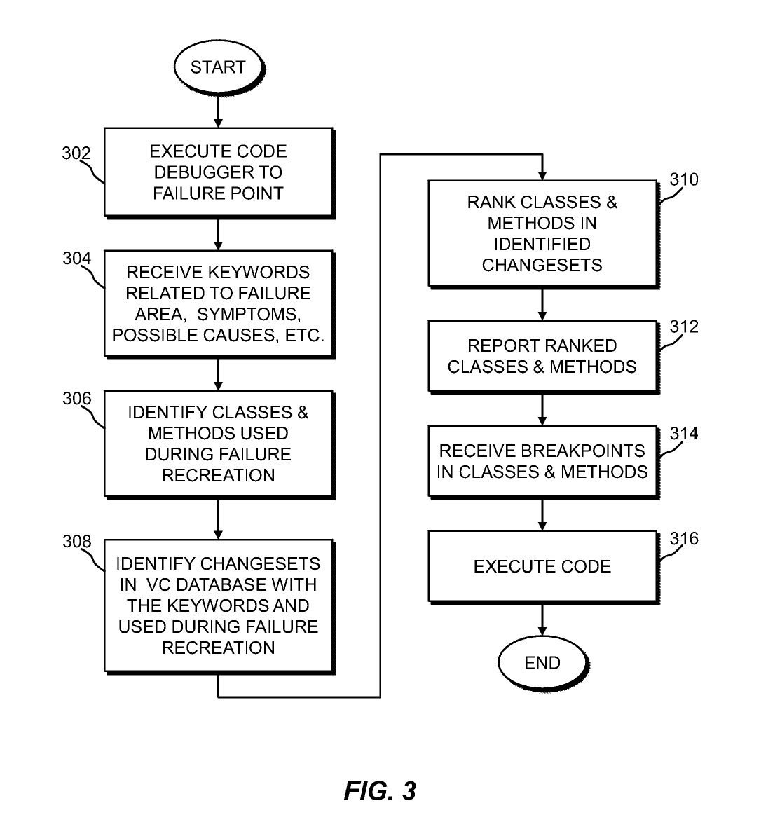

FIG. 3 is a flowchart showing operational steps of the predictive fault location system of FIG. 1, in accordance with an embodiment of the present invention. A debugger 104 executes a program under test to a point of failure (step 302). Debugger 104 receives keywords or a natural language description, via user interface 202, that describe the failure (step 304). For example, the keywords or a natural language description may describe failure symptoms, possible causes, and possible program code areas related to the failure.

Method and class tracking module 204 identifies the methods and classes that are invoked during the execution to failure of the program under test (step 306). Version control database interface 206 identifies changesets associated with defect entries in version control database 108 that contain keywords and phrases received, via user interface 202, that describe the failure (step 308). Changesets that are associated with the entered keywords and phrases that also contain the methods and classes that were invoked during the execution of a portion code under test are identified. This information, at least keying off of method or class, is passed to method and class ranking module 208 for analysis.

Method and class ranking module 208 ranks the list of identified methods and classes received from version control database interface 206 as a function of likelihood of each identified method and class having been the cause of the failure (step 310). The list of methods and classes (or a portion thereof) is reported, for example, via user interface module 202 (step 312). In this embodiment, the report indicates the respective rankings of the methods and classes that are included in the report's list. Debugger module 104 receives, for example, breakpoints in methods and classes that are ranked high in the reported list (step 314), and the debugger begins executing the program under test (step 316).

As mentioned above, in certain embodiments, keywords or a natural language description that describe the failure may not be received (see step 304). In these embodiments, for example, version control database interface 206 receives from method and class tracking module 204 the list of methods and classes that were invoked during the execution of the portion of code under test, and identifies changesets in version control database 108 that contain the methods and classes. This information, at least keying off of method or class, is passed to method and class ranking module 208 for analysis.

FIG. 4 is a block diagram of components of computing device 102 of predictive fault location system 100 of FIG. 1, in accordance with an embodiment of the present invention. It should be appreciated that FIG. 4 provides only an illustration of one implementation and does not imply any limitations with regard to the environments in which different embodiments may be implemented. Many modifications to the depicted environment may be made.

Computing device 102 can include one or more processors 402, one or more computer-readable RAMs 404, one or more computer-readable ROMs 406, one or more tangible storage devices 408, device drivers 412, read/write drive or interface 414, network adapter or interface 416, all interconnected over a communications fabric 418. Communications fabric 418 can be implemented with any architecture designed for passing data and/or control information between processors (such as microprocessors, communications and network processors, etc.), system memory, peripheral devices, and any other hardware components within a system.

One or more operating systems 410, and debugger module 104, are stored on one or more of the computer-readable tangible storage media 408 for execution by one or more of the processors 402 via one or more of the respective RAMs 404 (which typically include cache memory). In the illustrated embodiment, each of the computer-readable tangible storage media 408 can be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Computing device 102 can also include a R/W drive or interface 414 to read from and write to one or more portable computer-readable tangible storage devices 426. Debugger module 104 on computing device 102 can be stored on one or more of the portable computer-readable tangible storage devices 426, read via the respective R/W drive or interface 414 and loaded into the respective computer-readable tangible storage media 408.

Computing device 102 can also include a network adapter or interface 416, such as a TCP/IP adapter card or wireless communication adapter (such as a 4G wireless communication adapter using OFDMA technology). Debugger module 104 on computing device 102 can be downloaded to the computing device from an external computer or external storage device via a network (for example, the Internet, a local area network or other, wide area network or wireless network) and network adapter or interface 416. From the network adapter or interface 416, the programs are loaded into the computer-readable tangible storage media 408. The network may comprise copper wires, optical fibers, wireless transmission, routers, firewalls, switches, gateway computers and/or edge servers.

Computing device 102 can also include a display screen 420, a keyboard or keypad 422, and a computer mouse or touchpad 424. Device drivers 412 interface to display screen 420 for imaging, to keyboard or keypad 422, to computer mouse or touchpad 424, and/or to display screen 420 for pressure sensing of alphanumeric character entry and user selections. The device drivers 412, R/W drive or interface 414 and network adapter or interface 416 can comprise hardware and software (stored in computer-readable tangible storage device 408 and/or ROM 406).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Based on the foregoing, a computer system, method and program product have been disclosed for a predictive fault location system. However, numerous modifications and substitutions can be made without deviating from the scope of the present invention. Therefore, the present invention has been disclosed by way of example and not limitation.

What is claimed is:

1. A method for identifying a code segment that has a likelihood of causing a program failure, the method comprising:
executing, by one or more processors, a program code to a failure point;
identifying, by one or more processors, a plurality of identified code segments executed in the program code prior to the failure point;
identifying, by one or more processors, one or more changesets that contain at least one of the identified code segments; and
ranking, by one or more processors, the identified code segments as a function of likelihood that each respectively ranked identified code segment caused the failure point, based, at least in part, on the identified changesets.

2. A method in accordance with claim 1, further comprising reporting, by one or more processors, at least some of the ranked code segments along with an indication of the ranking.

3. A method in accordance with claim 1, further comprising:
receiving, by one or more processors, keywords related to the program failure;
and wherein identifying changesets further comprises:
identifying, by one or more processors, changesets related to the keywords that contain changes to the identified code segments.

4. A method in accordance with claim 1, wherein a code segment includes one or more of:
program module, class, method, object, subroutine, function, procedure, and division.

5. A method in accordance with claim 1, wherein a changeset includes one or more of: the name of code segments that were changed; the defects to which the changeset is related; the time of the revision; and the size of the revision.

6. A method in accordance with claim 1, wherein ranking the identified code segments comprises ranking the identified code segments as a function of one or more of: the number of changesets that contain a code segment; the time of a revision to a code segment; and the size of a revision to a code segment.

7. A computer program product for identifying a code segment that has a likelihood of causing a program failure, the computer program product comprising:
one or more computer-readable storage media and program instructions stored on the one or more computer-readable storage media, the program instructions comprising:
program instructions to execute a program code to a failure point;
program instructions to identify a plurality of code segments executed in the program code prior to the failure point;
program instructions to identify one or more changesets that contain at least one of the identified code segments; and
program instructions to rank the identified code segments as a function of likelihood that each respectively ranked identified code segment caused the failure point, based, at least in part, on the identified changesets.

8. A computer program product in accordance with claim 7, further comprising program instructions to report at least some of the ranked code segments along with an indication of the ranking.

9. A computer program product in accordance with claim 7, further comprising:
program instructions to receive keywords related to the program failure;
and wherein the program instructions to identify changesets further comprises:
program instructions to identify changesets related to the keywords that contain changes to the identified code segments.

10. A computer program product in accordance with claim 7, wherein a code segment includes one or more of: program module, class, method, object, subroutine, function, procedure, and division.

11. A computer program product in accordance with claim 7, wherein a changeset includes one or more of: the name of code segments that were changed; the defects to which the changeset is related; the time of the revision; and the size of the revision.

12. A computer program product in accordance with claim 7, wherein the program instructions to rank the identified code segments comprises program instructions to rank the identified code segments as a function of one or more of: the number of changesets that contain a code segment;
the time of a revision to a code segment; and the size of a revision to a code segment.

13. A computer system for identifying a code segment that has a likelihood of causing a program failure, the computer system comprising:
one or more computer processors, one or more computer-readable storage media, and program instructions stored on the computer-readable storage media for execution by at least one of the one or more processors, the program instructions comprising:
program instructions to execute a program code to a failure point;
program instructions to identify a plurality of code segments executed in the program code prior to the failure point;
program instructions to identify one or more changesets that contain at least one of the identified code segments; and
program instructions to rank the identified code segments as a function of likelihood that each respectively ranked identified code segment caused the failure point, based, at least in part, on the identified changesets.

14. A computer system in accordance with claim 13, further comprising program instructions to report at least some of the ranked code segments along with an indication of the ranking.

15. A computer system in accordance with claim 13, further comprising:
program instructions to receive keywords related to the program failure;
and wherein the program instructions to identify changesets further comprises:
program instructions to identify changesets related to the keywords that contain changes to the identified code segments.

16. A computer system in accordance with claim 13, wherein a code segment includes one or more of: program module, class, method, object, subroutine, function, procedure, and division.

17. A computer system in accordance with claim 13, wherein a changeset includes one or more of: the name of code segments that were changed; the defects to which the changeset is related;
the time of the revision; and the size of the revision.

18. A computer system in accordance with claim 13, wherein the program instructions to rank the identified code segments comprises program instructions to rank the identified code segments as a function of one or more of: the number of changesets that contain a code segment; the time of a revision to a code segment; and the size of a revision to a code segment.
